(19) United States
(12) Patent Application Publication
(10) Pub. No.: US 2012/0069695 A1
(43) Pub. Date: Mar. 22, 2012

(54) Capstir

(76) Inventor: Devon Sory, West Palm Beach, FL (US)

(21) Appl. No.: 12/887,411

(22) Filed: Sep. 21, 2010

Related U.S. Application Data
(63) Continuation-in-part of application No. 29/375,376, filed on Sep. 21, 2010, now abandoned.
Application No. 29/375,376 is a continuation-in-part of application No. 29/375,378, filed on Sep. 21, 2010.

(51) Int. Cl. B01F 15/00

(52) U.S. Cl. 366/129

(57) ABSTRACT

A Capstir is any handheld device or instrument that is manufactured, sold, promoted, distributed, or used for the primary purpose of mixing, or stirring, laundry detergent/softener, with the water in the washing machine. The primary goal of a Capstir is to better dissolve and distribute the laundry detergent/softener in the water in the washing machine. It is believed that a Capstir is the first, and only, handheld device that claims the preceding to be its primary purpose and primary goal. Additionally, the surface area of a Capstir may also serve as a place for companies to advertise/promote other products and services they offer.

### BACKGROUND OF THE INVENTION

Often times, concentrated fluids or powders, as well as other substrates need to be mixed with water or oils for washing, cleaning, lubricating, ingesting, consuming or topical uses. This can often be “on the fly” or when one is unprepared for the activity, or can be in a setting such as a rural camp or military field kitchen, where there are few instruments or tools readily available to act as a “stirrer”. Even in a laundry room setting or a Laundromat, there may not be any readily available tools for easy dispensing or mixing of concentrated detergent evenly with water in the washing machine. Without proper mixing of fluid substrates, or solid with fluid substrates, mixtures have agglomerations of substrates which are uneven, and are less likely to be activated to their full potential.

It would be therefore convenient if, along with a detergent container, scoop or fabric softener, there were also something, such as an elongated or extensible tool readily available for easy dispensing of fluid or powder detergent, and convenient mixing of such with as many parts water as needed in the washing machine. Moreover, the opportunity for advertising, given the length, shape and form of such an instrument, could easily make up for the added cost of including an extra instrument with the fluid or solid substrate being sold. Though it is foreseen that the laundry industry is an ideal application for this kind of an elongated or extensible instrument for dispensing, mixing and distributing a number of substrates, it is also appropriate for mixing and dispensing in the dishwashing, medical preparations, beverages, paints, chemical industries, and many other household or industrial applications and the disclosure is not in any way meant to be seen as a limitation on the uses of such an item.

### SUMMARY OF THE INVENTION

What is intended as the invention is an elongated or extensible instrument which facilitates the dispensing, mixing and distribution of a plurality of substrates, of which at least one is a fluid or powder and would be the solvent of a liquid solution or mixture.

One possible embodiment of the invention is an elongated or extensible, liquid-proof instrument for mixing purposes. It is further conceived that such an instrument could be telescoping in nature and semi-conical, cylindrical, cubical, pyramidal or funnel-like in shape.

A further embodiment of the invention foresees the placement of this instrument on the cap of the container of one of the substrates being distributed for the purposes of mixing with other materials.

Yet another embodiment of the invention foresees the placement of this instrument on the side of the container, detachable for use separately for mixing and dispensing.

Yet another embodiment of the invention foresees the above instrument manufactured from silica, polyurethane, PVC, rubber or plastic.

Yet another embodiment of the invention foresees the above instrument comprising individual telescoping components, fitting together in an interlocking and concentric manner.

A further embodiment of the invention conceives the placement and display of promotional messages and images on the surface area of the instrument for the purpose of advertising along with the sale and marketing of the instrument.

### BRIEF DESCRIPTION OF THE DRAWINGS AND PHOTOGRAPHS

Reference is had to the accompanying drawings and photographs, forming part thereof, wherein the dominant feature is the telescoping arrangement of the panels and the plurality of sections positioned to produce in side elevation, when extended, an elongated handheld mixing device for substrates.

It is further conceived that such an instrument could be conical, cylindrical, cubical, pyramidal or funnel-like in shape, wherein the dominant feature is that the shapes are telescoping in nature.

The design is the configuration and plurality of sections shown in solid lines in the Drawings. The broken lines in the figures are for illustrative purposes only and form no part of the design. Drawings of the design are included, in which:

FIG. 1 is a general use cap, not claimed, that will serve as a base;

FIG. 2 is a non-extended, front view with the optional cover, wherein the rear and sides are identical in appearance with the front;

FIG. 3 is a non-extended, top plan view without the optional cover, illustrating the concentric telescoping sections;

FIG. 4 is an extended, front view thereof, wherein the rear and sides are identical in appearance with the front;

It is also noted that the surface area of my new design may serve as a place for companies to display promotional messages and images, as well as advertise other brands and services they offer.

Photographs of the design that depict the Drawings listed above are included, in which:

FIG. 5 is a general use cap, not claimed, that will serve as a base;

FIG. 6 is a non-extended, front view with the optional cover,

FIG. 7 is a non-extended, top plan view without the optional cover, illustrating the concentric telescoping sections;

FIG. 8 is a non-extended, top plan view with the optional cover;

FIG. 9 is an extended, front view thereof, illustrating that the surface area of my new design may serve as a place for companies to display promotional messages and images, as well as advertise other brands and services they offer.

FIG. 10 is an extended, side view thereof, illustrating that the surface area of my new design may serve as a place for companies to display promotional messages and images, as well as advertise other brands and services they offer.

FIG. 11 is an extended, front view thereof, illustrating that the surface area of my new design may serve as a place for companies to display promotional messages and images, as well as advertise other brands and services they offer.

I claim: The ornamental design for a Cap Stir substantially as shown and described.

### DETAILED DESCRIPTION

The invention conceived here can be any handheld device or instrument that is manufactured, sold, promoted, distributed or used for the primary purpose of mixing together a plurality of substrates, and could be distributed along with a container of one of the substrates.

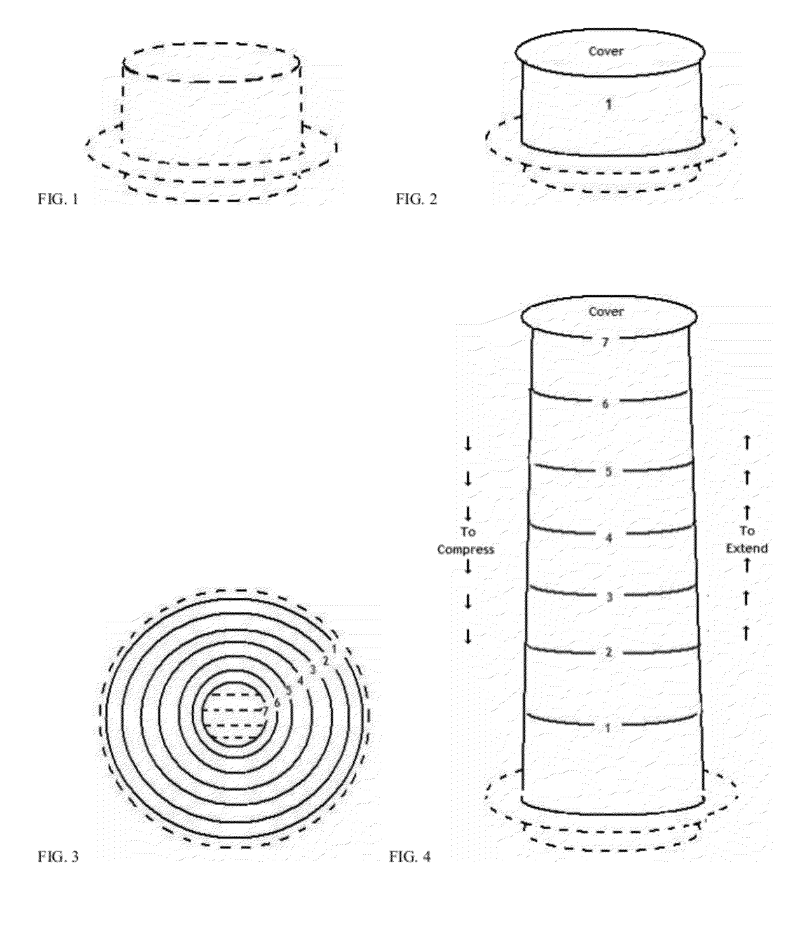

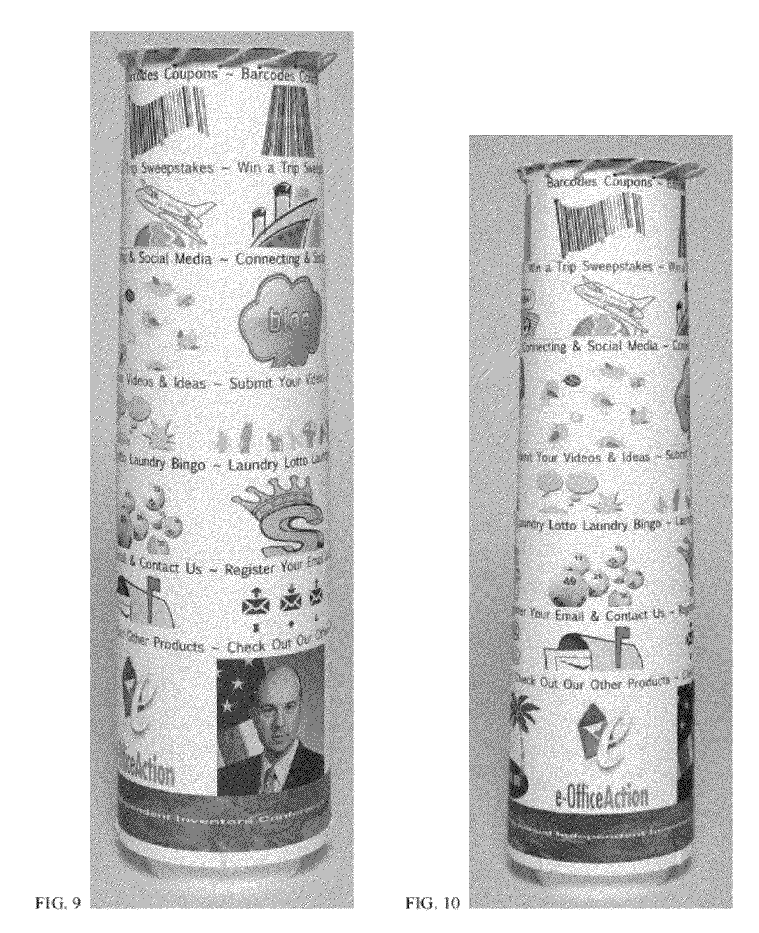

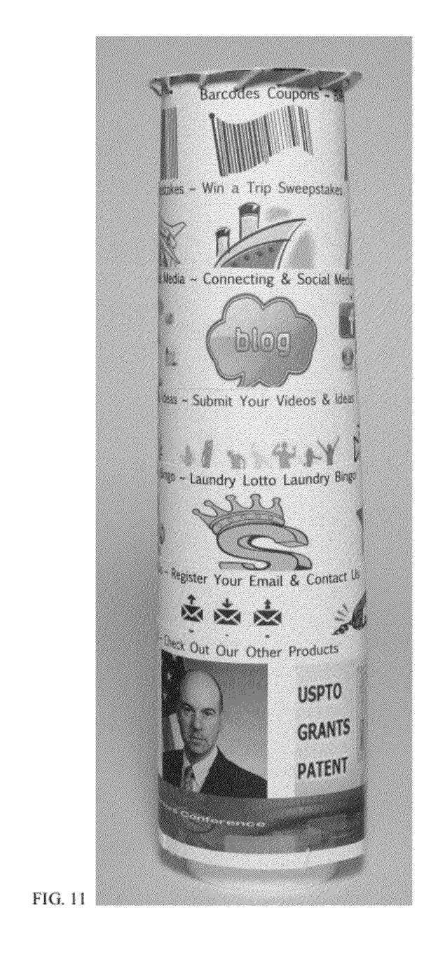

A preferred form of the invention would be a retractable, extendible or telescoping design which would sit atop the container cap of one of the substrates being mixed. It would normally be compressed into a smaller size, as illustrated in FIG. 2 and FIG. 6, when sold, and then could be extended for usage as shown in FIGS. 4, 9, 10 and 11. The individual parts thereof, 1, 2, 3, 4, 5, 6 and 7 of the device would fit neatly into each other and could be neatly elongated by telescoping. Note that this illustration is in no way intended to limit the scope of the invention and the length as well as the number of parts could vary.

The dispensing function could be achieved by including a tube through the center of the parts, so that while the substrate is being poured and mixed in, it dispenses and distributes evenly through the mixture.

The container cap shown in FIG. 1 and FIG. 5 is merely intended to serve as a base for the telescoping or extending handheld instrument, and could also have an aperture so a measured amount of substrate is then dispensed through the extending design of the device, aiding its mixture.

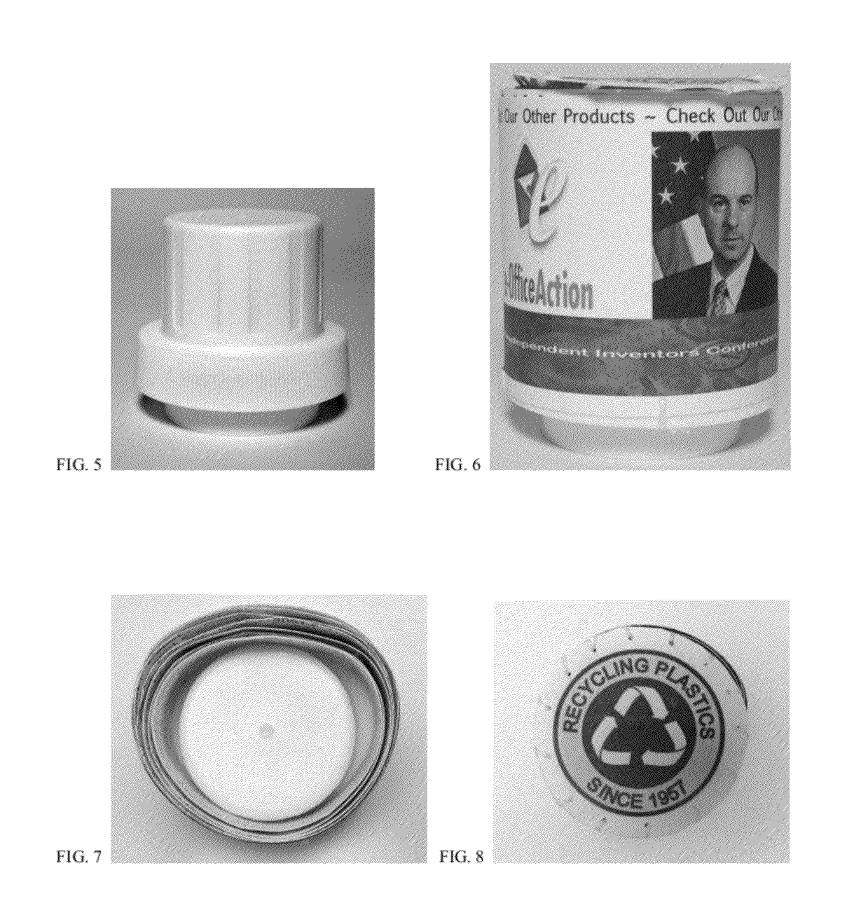

In FIG. 3 and FIG. 7, a top plan view of the concentric, interlocking parts is shown, as they fit together.

The device could optionally have a cover, as shown in FIGS. 2, 4, 6, 8, 9, 10 and 11, but is not necessary to achieve the goals of the invention.

The surface area of the instrument is ideal for the placement of ads, promotions, coupons, bar codes or other advertising material. Distributors of the particular substrate being sold would especially find this is a very attractive feature to market and advertise their other products, brands, promotions, contests, etc.

None of the features and embodiments disclosed here are intended as a limitation on the configuration of this device and any appropriate shape, form and size can be used, as long as the primary goals of mixing, dispensing, distributing and dissolving substrates are fulfilled.

It is claimed that:

1. A Capstir is any handheld device or instrument that is manufactured, sold, promoted, distributed or used for the primary purpose of mixing laundry detergent/softener with the water in the washing machine.

2. The primary goal of a Capstir is to better dissolve and distribute the laundry detergent/softener in the water in the washing machine.

3. Capstir is the first invention of its kind in regard to it being a handheld device with the primary purpose as stated in claim 1 and primary goal as stated in claim 2.

4. Any handheld device that embodies claim 1 and claim 2 can be considered a Capstir.

5. A Capstir can be in any shape, form, size, color, or material.

6. A Capstir can be manufactured directly onto a laundry detergent bottle, box, or cap.

7. A Capstir that is manufactured directly onto a laundry detergent box, bottle, or cap, is considered to be a revolutionary design to the laundry box, bottle, or cap since it is adding this useful new feature.

8. A Capstir can be manufactured separately from a laundry detergent bottle, box, or cap and applied/affixed later, if so desired.

9. A Capstir can be manufactured separately as an independent product and still considered a Capstir so long as it is handheld and embodies the statements made in claim 1 and claim 2.

10. The surface area of a Capstir may also serve as a place for companies to advertise/promote other products and services they offer.

11. Thank you for your time and consideration.
